(19) United States
(12) Patent Application Publication
(10) Pub. No.: US 2007/0088828 A1
(43) Pub. Date: Apr. 19, 2007

(54) System, method and program product for executing an application

(75) Inventors: Maheswara R. Inampudi, Aurora, IL (US); James W. Penney, Trumbull, CT (US)

Correspondence Address: SILVY ANNA MURPHY, 100 TURNBERRY LANE, CARY, NC, 27511, US

(73) Assignee: International Business Machines Corporation, Armonk, NY (US)

(21) Appl. No.: 11/252,490

(22) Filed: Oct. 18, 2005

(51) Int. Cl. G06F 15/173

(52) U.S. Cl. 709/226

(57) ABSTRACT

A system, method and program product for executing an application is provided. The system comprises a local infrastructure configured to execute an application in a local environment, a grid infrastructure configured to execute the application in a grid environment, and a local-grid-facade having a parameter switch for selecting either the local environment or the grid environment and for executing the application in the selected environment. Preferably, the local-grid facade includes a local-grid controller module that has the parameter switch and is implemented within each of the local infrastructure and the grid infrastructure. Preferably, the local infrastructure comprises a local node configured to execute one or more tasks pertaining to the application and preferably, the grid infrastructure comprises a plurality of grid nodes connected via a network communications channel and configured to execute one or more tasks pertaining to the application.

### FIELD OF THE INVENTION

The present invention relates to a system, method and computer program product for executing an application. More particularly, the present invention relates to a system, method and computer program product for executing an application designed for a grid computing system by selecting to execute the application either in a local environment or in a grid environment.

### BACKGROUND OF THE INVENTION

Grid computing technology allows multiple interconnected computers to work together on large grid applications, such as computational problems, that would be impossible to do on a single machine. In order to feasibly manage such overwhelming amounts of computational processing, the computational problem may be divided into several smaller, more manageable jobs or tasks. This type of shared processing of grid application(s) is possible in part because of the enforced or incidental idle processor time of many personal and business computers. Additionally, grid computing systems may allow for shared storage across a plurality of nodes within the system. In this way, data may be stored remotely on the system, in the form of a backup, for example, and allow large amounts of data to be virtually stored by a single node. This changing landscape in grid computing has led to the development of numerous grid frameworks that are designed to support applications that run over a grid. However, to make applications ready for a grid framework, developers need to go through the process of understanding the complex structure of the grid system architecture and also the underlying framework that is being used. As such, there is a need to simplify the development as well as deployment of such applications that are designed for a grid system.

### SUMMARY OF THE INVENTION

In a first aspect of the invention, there is provided a system for executing an application. The system comprises a local infrastructure configured to execute an application in a local environment, a grid infrastructure configured to execute the application in a grid environment, and a local-grid-facade having a parameter switch for selecting either the local environment or the grid environment and for executing the application in the selected environment. Preferably, the local infrastructure comprises a local node configured to execute one or more tasks pertaining to the application and preferably, the grid infrastructure comprises a plurality of grid nodes connected via a network communications channel, each of the plurality of grid nodes being configured to execute one or more tasks pertaining to the application. Preferably, the local-grid facade is implemented within each of the local infrastructure and the grid infrastructure. The local-grid facade implemented within the local infrastructure further comprises a local-grid controller module configured to schedule the one or more tasks to be executed on the local node. Further, the local-grid controller module includes the parameter switch and a results collector module configured to collect results pertaining to the one or more tasks executed on the local node. The local-grid facade implemented within the grid infrastructure further comprises a local-grid controller module configured to schedule the one or more tasks on one or more of the plurality of grid nodes and a results collector module configured to collect results pertaining to the one or more tasks from the local node. Preferably, the local environment comprises the local infrastructure having the local-grid facade implemented thereon, such that the local environment is configured to test and deploy the application in the local environment. Also, the local infrastructure is configured to receive an input pertaining to the execution of the application from an application client. Further, the grid environment preferably comprises the grid infrastructure having the local-grid facade implemented thereon, such that the grid environment is configured to deploy the application in the grid environment. Preferably, the grid infrastructure also is configured to receive an input pertaining to the execution of the application from the application client. More preferably the local environment includes a results summary module configured to consolidate results pertaining to the one or more tasks received from the local node, and preferably the grid environment includes a grid results summary module configured to consolidate results pertaining to the one or more tasks received from the one or more of the plurality of grid nodes.

In another aspect of the invention, there is provided a method for executing an application using the local-grid facade or code. The method includes providing a local-grid-facade having a parameter switch for selecting either a local environment or a grid environment for executing an application, selecting either the local environment or the grid environment for executing the application, receiving one or more tasks pertaining to the application to be executed, and executing the one or more tasks in either the local environment or the grid environment selected. The method further comprises the step of forwarding to an application client results corresponding to the one or more tasks executed in either the local environment or the grid environment selected. Preferably the receiving step further comprises the step of communicating with the application client as to how many tasks to divide the application into for execution in either the local environment or the grid environment selected and scheduling the one or more tasks received from the application client for execution in either the local environment or the grid environment selected. Also, preferably the forwarding step further comprises the steps of collecting the results corresponding to the one or more tasks executed either in the local environment or the grid environment selected and providing a summary of the results collected to the application client. Further, preferably, if the local environment is selected in the parameter switch, the one or more tasks are scheduled to be executed on a local node of a local infrastructure, and preferably if the grid environment is selected in the parameter switch, the one or more tasks are scheduled to be executed on one or more of a plurality of grid nodes of a grid infrastructure.

In yet another aspect of the invention, there is provided a computer program product for executing an application. The computer program product comprises a computer readable medium, first program instructions to execute an application in a local environment, second program instructions to execute the application in a grid environment, and third program instructions to provide a parameter switch for selecting either the local environment or the grid environment for executing the application. The computer program product further comprises fourth program instructions to collect results corresponding to the execution of the application either in the local environment or the grid environment. Preferably, the first, second, third and fourth program instructions are stored on the medium. Further, if the parameter switch is selected for executing the application in the local environment, the third program instructions further includes instructions to schedule one or more tasks pertaining to the application in a local infrastructure, and preferably if the parameter switch is selected for executing the application in the grid environment, the third program instructions further includes instructions to schedule one or more tasks pertaining to the application in a grid infrastructure. Preferably the local infrastructure comprises a local node configured to execute the one or more tasks pertaining to the application, and preferably the grid infrastructure comprises a plurality of grid nodes connected via a network communications channel, each of the plurality of grid nodes being configured to execute the one or more tasks pertaining to the application. More preferably the local infrastructure is configured to receive an input pertaining to the application from an application client, and preferably the grid infrastructure is configured to receive an input pertaining to the application from the application client. Preferably the fourth program instructions includes instructions to consolidate results from either the local node or one or more of the plurality of grid nodes pertaining to the execution of the application.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 represents a system for executing an application that includes a local infrastructure with a local-grid facade and a grid infrastructure with a local-grid facade, in accordance with an embodiment of the present invention.

FIG. 2A is a schematic block diagram illustrating a system for executing an application in a local environment using a local-grid facade, in accordance with an embodiment of the present invention.

FIG. 2B is a schematic block diagram illustrating an alternate system for executing an application in a local environment using a local-grid facade, in accordance with an embodiment of the present invention.

FIG. 3A is a schematic block diagram illustrating a system for executing an application in a grid environment using a local-grid facade, in accordance with an embodiment of the present invention.

FIG. 3B is a schematic block diagram illustrating an alternate system for executing an application in a grid environment using a local-grid facade, in accordance with an embodiment of the present invention.

FIG. 4 is a flowchart depicting a method of executing an application in either a local environment or a grid environment using a local-grid facade, in accordance with an embodiment of the present invention.

FIG. 5 is a schematic block diagram illustrating an example of executing an application in a local environment using a local-grid facade, in accordance with an embodiment of the present invention.

FIG. 6 is a schematic block diagram illustrating an example of an application that is executed in a local environment using a local-grid facade versus the same application being deployed onto a grid computing system, in accordance with an embodiment of the present invention.

### BEST MODE FOR CARRYING OUT THE INVENTION

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

In one embodiment, the present invention provides a system for executing an application using a local-grid facade. In particular, the present invention provides a system for executing an application that is developed or designed for a grid computing framework or system. The system includes a local infrastructure configured to execute an application in a local environment, a grid infrastructure configured to execute the application in a grid environment, and a local-grid-facade having a parameter switch for selecting either the local environment or the grid environment and for executing the application in the selected environment. Preferably, the local-grid facade is implemented within the local infrastructure and within the grid infrastructure, such that the application can be executed either in the local environment or the grid environment that is selected for executing the application. Preferably, the local infrastructure includes a local node that is configured to execute one or more tasks pertaining to the application and preferably, the grid infrastructure includes a plurality of grid nodes connected via a network communications channel, with each of the plurality of grid nodes being configured to execute one or more tasks pertaining to the application. Further, preferably, the local-grid facade that is implemented within the local infrastructure includes a local-grid controller module configured to schedule one or more tasks to be executed on the local node, and includes a results collector module configured to collect results pertaining to the one or more tasks executed on the local node. More preferably, the local environment includes the local infrastructure having the local-grid facade implemented thereon, such that the local environment is configured to test and deploy the application in the local environment. More preferably, the local infrastructure is configured to receive an input pertaining to the execution of the application from an application client. Further, preferably, the local environment includes a results summary module that is configured to consolidate results pertaining to the one or more tasks received from the local node. In addition, the local-grid facade implemented within the grid infrastructure preferably includes a local-grid controller module configured to schedule one or more tasks on one or more of the plurality of grid nodes, and includes a results collector module that is configured to collect results pertaining to the one or more tasks from the plurality of grid nodes. Preferably, the grid environment includes the grid infrastructure having the local-grid facade implemented thereon, such that the grid environment is configured to deploy the application in the grid environment. More preferably, the grid infrastructure is configured to receive an input pertaining to the execution of the application from the application client. Further, preferably, the grid environment includes a results summary module that is configured to consolidate results pertaining to the one or more tasks received from one or more of the plurality of grid nodes.

As used herein, the term “application” refers to an application that is developed or designed for a grid computing system, but where the application is not yet implemented on a grid computing system. As such, the following description will focus on testing and/or deploying the application using a local-grid facade that is implemented on a local infrastructure to simulate a grid computing system when a grid computing system is not available, so that the application can be eventually deployed in a grid computing system. The term “application client” refers to the program on a client machine that wants an application to be executed either in a local environment or a grid environment. Further, the term “local-grid facade” refers to code that is implemented within both the local infrastructure and within the grid infrastructure. The local-grid facade code includes a parameter switch whose properties can be set, such that a developer of an application designed for a grid system can select whether the application should be executed in a local environment or a grid environment. Additionally, the term “local infrastructure” refers to a local node or one computer workstation, whereas, the term “grid infrastructure” refers to one or more grid nodes or grid client-servers that are connected via some network communications channel. Moreover, the term “local environment” refers to the local infrastructure having the local-grid facade implemented thereon and the “grid environment” refers to the grid infrastructure having the local-grid facade implemented thereon. Also, the term “task(s)” or “job(s)” or “units of work” or “thread(s)” refer to one or more smaller pieces that an application is divided into by an application client.

Further, many of the functional units that are included in the local-grid facade are labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Also, modules may be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module. Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, over disparate memory devices, and may exist, at least partially, merely as electronic signals on a system or network. Furthermore, modules may also be implemented as a combination of software and one or more hardware devices. For instance, a module may be embodied in the combination of a software executable code stored on a memory device. In a further example, a module may be the combination of a processor that operates on a set of operational data. Still further, a module may be implemented in the combination of an electronic signal communicated via transmission circuitry.

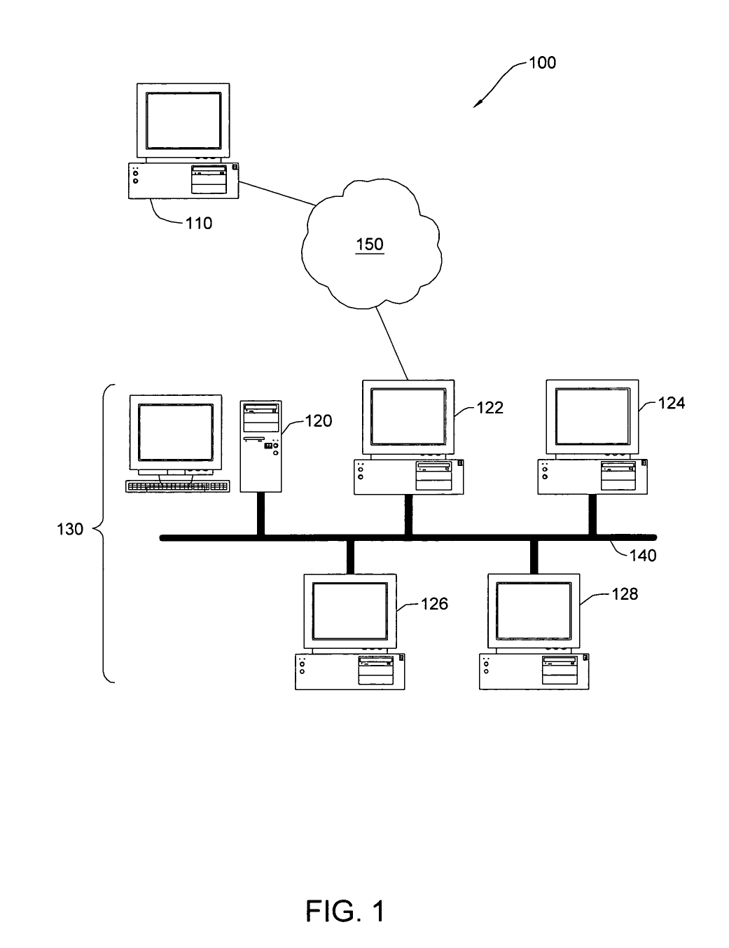

Reference is now made to FIGS. 1 through 4, which illustrate various embodiments and aspects of a system for executing an application using the local-grid facade, in accordance with the invention. Turning to FIG. 1, reference number 100 in FIG. 1 refers to a system for executing an application which includes a local infrastructure 110 with a local-grid facade implemented thereon (not specifically shown in FIG. 1) and a grid infrastructure 130 with a local-grid facade implemented thereon (not specifically shown in FIG. 1), in accordance with an embodiment of the present invention. As shown in FIG. 1, both the local infrastructure 110 and the grid infrastructure 130 of the system 100 operate over the Internet 150, which serves as a communications channel for the various components of the system. Further, the grid infrastructure 130 shown in FIG. 1 is similar to a local area network (LAN) and includes five client-servers 120, 122, 124, 126 and 128, all five of these respective client-servers being connected via a communications channel 140. The communications channel 140 may be, in one embodiment, an Ethernet communications channel, a wireless communications channel, or another equivalent communications channel. Although the depicted grid infrastructure 130 is shown to include five client-servers 120-128, the grid infrastructure 130 may comprise a combination of various network configurations having fewer or more client-servers, or alternate client-server configurations.

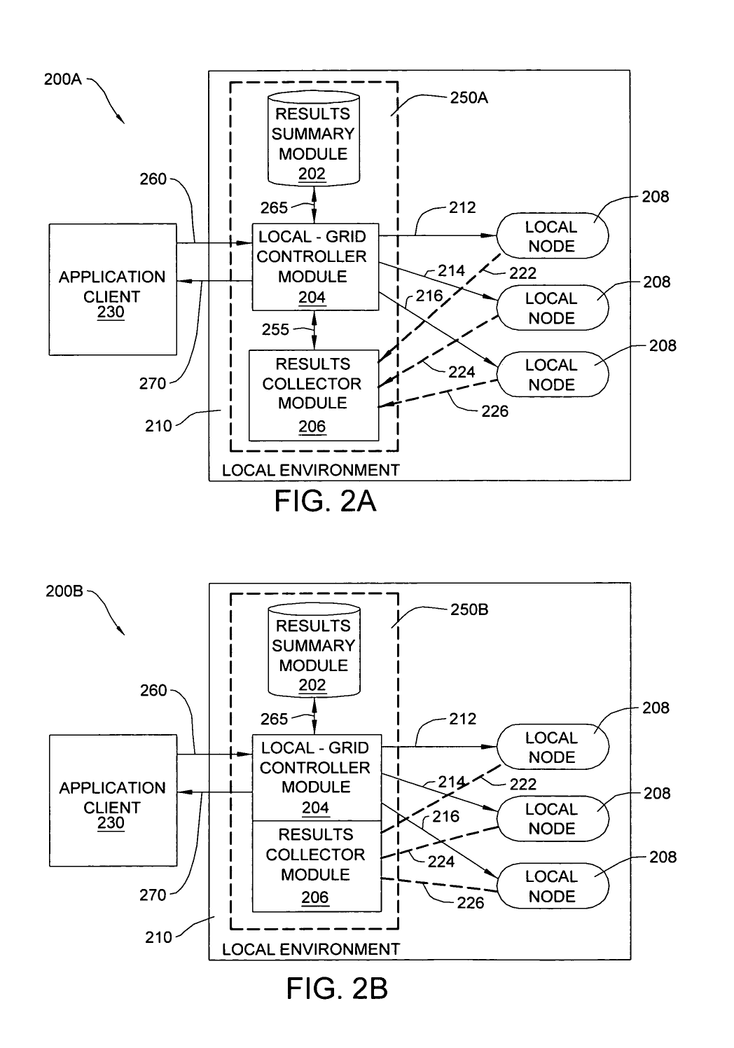

Turning to FIGS. 2A and 2B, reference numbers 200A and 200 B both illustrate the execution of an application designed for a grid system in which the parameter switch of the local-grid facade is set to execute the application in a local environment. The only difference between FIG. 2A and FIG. 2B is the configuration of the respective local-grid facade 250A and 250B, which is code that is implemented within the local node 208. As shown in FIG. 2A, the local-grid facade 250A includes several modules, namely, a local-grid controller module 204, a results collector module 206 and preferably also includes a results summary module 202. The local-grid controller module 204 of the local-grid facade 250A is configured to schedule the one or more tasks to be executed on the local node 208 with the local-grid controller module 204 including a parameter switch (not shown specifically in FIGS. 2A or 2B) for selecting either a local environment or a grid environment. Also, the local-grid controller module 204 is configured to interface with an application client 230, as shown in FIG. 2A. Further, the results collector module 206 is configured to collect results pertaining to the one or more tasks executed on a local node 208 and the results summary module 202 is configured to consolidate or summarize the results pertaining to the one or more tasks received from a local node 208 and collected by the results collector module 206. In another embodiment 200B shown in FIG. 2B, the local-grid facade 250B includes a local-grid controller module 204, a results collector module 206, but with the local-grid controller module 204 and the results collector module 206 being combined. Similar to the local-grid facade 250A, the local-grid facade 250B also preferably includes a results summary module 202. The remainder of FIG. 2B is the same as FIG. 2A, thus, although the remainder of the description references FIG. 2A, the description of FIG. 2B follows that of FIG. 2A. Referring to FIG. 2A, the local infrastructure, as shown, includes three separate local nodes having the reference number 208. Although, the local infrastructure is shown as three separate local nodes 208, these three separate local nodes represent one and the same local workstation or local node 208, which is configured to execute one or more tasks pertaining to the application. However, the local infrastructure is shown as separate local nodes in order to illustrate the grid simulation that occurs as a result of the local-grid facade 250A that is implemented on the local node 208, which together form the local environment 210 in which the application is executed.

If a local environment is selected in the parameter switch included within the local-grid controller module 204, the local-grid controller module 204 knows that the application is to be executed in a local environment. Accordingly, when an application client 230 calls or communicates with the local-grid controller module 204 to find out how many tasks or jobs or threads to split up or divide the application into, the local-grid controller module 204 tracks or manages the resources available on the local node, such as, processing capability, etc. and is able to communicate back to the application client 230 as to how many separate tasks/jobs it can schedule for execution on the local node 208. As a result, the application client 230 divides the application to be executed on the local node 208 into the appropriate number of tasks/jobs/threads corresponding to the task/job information communicated by the local-grid controller module 204. The one or more tasks of the application to be executed are sent (shown by the arrow 260) as one or more tasks to the local-grid controller module 204. In particular, in FIGS. 2A and 2B, the local-grid controller module 204 schedules (shown by the solid arrows 212, 214 and 216) three separate tasks on the local node 208. As such, the several tasks or jobs of an application may be executed concurrently, serially, or co-dependently on a local node. Preferably, the operating system of the local node 208 has implemented thereon multi-threading capabilities, for instance, implementation of the Java programming language multi-threading capabilities, Java.lang.Thread, so that multiple tasks can be executed locally on the local node. In addition, once the local node 208 has finished executing the individual tasks, the local node sends (shown by the dotted arrows 216, 224 and 226) the results of the executed tasks to the results collector module 206 (shown by dotted arrows 222, 224 and 226). The results collector module 206, preferably, communicates (shown by the double-sided arrow 255) the results directly to the local-grid controller module 204. Further, the local-grid controller module 204 may send the results collected by the results collector module 206 (shown by the double-sided arrow 265) to the results summary module 202, so that the results summary module 202 can consolidate or summarize the results received and return the results to the local-grid controller module 204 in a specific format that is desired. The local-grid controller module 204 forwards (shown by the arrow 270) the results either consolidated by the results summary module 202 or the results collected by the results collector module 206 to the application client 230. Alternatively, in one embodiment (not shown in FIG. 2A or 2B), the local node 208 can send the results to the local-grid controller module 204, which may send the results to the results collector module 206. The results collector module 206 collects the results and once all the results have been collected, the results collector module 206 sends the results that have been collected to the local-grid controller module 204. Further, the local-grid controller module 204 may send the collected results (shown by the double-sided arrow 265) to the results summary module 202, so that the collected results can be consolidated into a summary that summarizes the results in a desired format. The results summary module 202 then sends the results back (shown by the double-sided arrow 265) to the local-grid controller module 204, which forwards (shown by the arrow 270) the summarized results to the application client 230. Accordingly, the local-grid facade implemented within the local infrastructure simulates a grid computing system but executes the various tasks or threads pertaining to the application in a local environment.

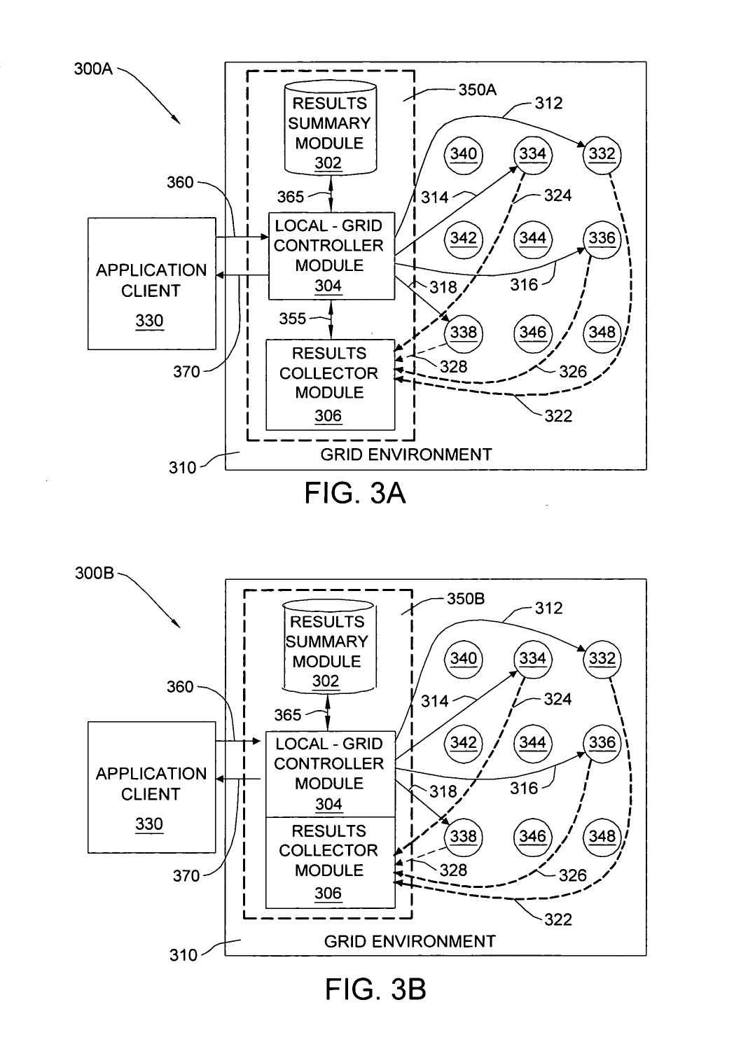

Reference is now made to FIGS. 3A and 3B, with reference numbers 300A and 300 B each illustrating the execution of an application designed for a grid system in which the parameter switch of the local-grid facade is set to execute the application in a grid environment. The only difference between FIG. 3A and FIG. 3B is the configuration of the respective local-grid facade 350A and 350B, which is code that is implemented within each of the grid nodes 332, 334,336,338, 340, 342, 344, 346 and 348. As shown in reference number 300A of FIG. 3A, the local-grid facade 350A includes several modules, namely, a local-grid controller module 304, a results collector module 306 and preferably also includes a results summary module 302. As shown by reference number 300B of FIG. 3B, the local-grid facade 350B includes a local-grid controller module 304, a results collector module 306, but with the local-grid controller module 304 and the results collector module 306 being combined. Similar to the local-grid facade 350A, the local-grid facade 350B also preferably includes a results summary module 302. The remainder of FIG. 3B is the same as FIG. 3A, thus, although the remainder of the description references FIG. 3A, the description of FIG. 3A is applicable to FIG. 3B. Referring to FIG. 3A, the grid infrastructure, as shown, includes the nine grid nodes 332, 334, 336, 338, 340, 342, 344, 346 and 348. The grid infrastructure includes each of the grid nodes 332, 334, 336, 338, 340, 342, 344, 346 and 348 and together with the local-grid facade 350A implemented on each of the grid nodes form the grid environment 310 in which the application is executed. Also, referring to FIG. 3A, the local-grid controller module 304 of the local-grid facade 350A is configured to schedule the one or more tasks pertaining to the application to be executed on one or more of the grid nodes 332, 334, 336, 338, 340, 342, 344, 346 and 348. Further, the local-grid controller module 304 includes the parameter switch (not shown specifically in FIGS. 3A or 3B) for selecting either a local environment or a grid environment. Also, the local-grid controller module 304 is configured to interface with an application client 330, as shown in FIG. 3A. Further, the results collector module 306 is configured to collect results pertaining to the one or more tasks executed on one or more of the grid nodes 332, 334, 336, 338, 340, 342, 344, 346 and 348, whereas, the results summary module 302 is configured to consolidate or summarize the results pertaining to the one or more tasks received from the one or more grid nodes 332, 334, 336, 338, 340, 342, 344, 346 and 348.

In particular, if a grid environment is selected in the parameter switch included within the local-grid controller module 304, the local-grid controller module 304 knows that the application is to be executed in a grid environment. Further the local-grid controller module 304 knows the number of grid nodes that are part of the grid environment that are available at a given moment to execute one or more jobs. Each of the grid nodes may allocate certain performance, storage or memory resources to the system for execution of the application and, preferably, the local-grid controller module 304 tracks or manages the resources available on the grid nodes so that it can schedule any tasks or jobs, as necessary. Alternatively, the local-grid controller module 304 can utilize a task management apparatus of the grid computing system to schedule tasks or jobs when operating in a grid environment. Accordingly, when an application client 330 calls or communicates with the local-grid controller module 304 to find out how many tasks or jobs or threads to split up or divide the application into, the local-grid controller module 304 has the information necessary to communicate back to the application client 330 as to how many separate task/jobs/threads it can schedule for execution on the one or more grid nodes 332, 334, 336, 338, 340, 342, 344, 346 and 348. As a result, the application client 230 divides the application to be executed by the one or more grid nodes 332, 334, 336, 338, 340, 342, 344, 346 and 348 into the appropriate number of tasks/jobs/threads corresponding to the task/job information communicated by the local-grid controller module 304. The one or more tasks of the application to be executed are sent (shown by the arrow 360) by the application client 330 to the local-grid controller module 304 as one or more tasks. In particular, in FIGS. 3A and 3B, the local-grid controller module 304 schedules (shown by the solid arrows 312,314,316 and 318) four separate tasks on four of the grid nodes, namely, grid node 332, grid node 334, grid node 336 and grid node 338. However, as shown in FIGS. 3A and 3B, the grid nodes 340, 342, 344, 346 and 348 are not sent any tasks pertaining to the application. The grid nodes 340, 342, 344, 346 and 348 may not have been sent any tasks perhaps because there were only four tasks pertaining to the application that needed to be executed or perhaps it may be the case that the grid nodes 340, 342, 344, 346 and 348 are not available for one or more reasons, such as lack of processor capability, processor capacity, storage capacity, etc.

Further, once each of the grid nodes 332, 334, 336 and 338 has finished executing the individual tasks, each of the respective grid nodes sends (shown by the dotted arrows 322, 324, 326 and 328) the results of the executed tasks to the results collector module 306. The results collector module 306, preferably, communicates the results received from the grid nodes 332, 334, 336 and 338 to the local-grid controller module 304, as shown by the double-sided arrow 355 in FIG. 3A. Further, the local-grid controller module 204 may send (shown by the double-sided arrow 365) the results collected by the results collector module 306 to the results summary module 302, so that the results summary module 302 can consolidate or summarize the results in a specific format that is desired and return the results to the local-grid controller module 304. The local-grid controller module 304 forwards (shown by the arrow 370) the results either consolidated by the results summary module 302 or the results collected by the results collector module 306 to the application client 330. Alternatively, in one embodiment (not shown in FIG. 3A or 3B), the grid nodes can send the results directly to the local-grid controller module 304, which may send the results to the results collector module 306. The results collector module 306 collects the results and once all the results have been collected, the results collector module 306 sends the results that have been collected to the local-grid controller module 304. Further, the local-grid controller module 304 can send the collected results (shown by the double-sided arrow 365) to the results summary module 302 so that the collected results can be consolidated into a summary that summarizes the results in a desired format. The results summary module 302 then sends the results back (shown by the double-sided arrow 365) to the local-grid controller module, which forwards (shown by the arrow 370) the summarized results to the application client 330. Accordingly, the several tasks or jobs of the application may be executed concurrently, serially, or co-dependently on one or more of the various grid nodes 332, 334, 336, 338, 340, 342, 344, 346 and 348 in the grid environment.

In another aspect of the invention, there is provided a method for executing an application using the local-grid facade. The method includes the steps of providing a local-grid-facade having a parameter switch for selecting either a local environment or a grid environment for executing an application, selecting either the local environment or the grid environment for executing the application, receiving one or more tasks pertaining to the application to be executed, and executing the one or more tasks in either the local environment or the grid environment selected. The method further includes the step of forwarding to an application client results corresponding to the one or more tasks executed in either the local environment or the grid environment selected. Preferably, the receiving step further includes the step of communicating with the application client as to how many tasks to divide up the application into for execution in either the local environment or the grid environment selected, and scheduling the one or more tasks received from the application client for execution in either the local environment or the grid environment selected. Preferably the forwarding step further includes the steps of collecting the results corresponding to the one or more tasks executed either in the local environment or the grid environment selected and providing a summary of the results collected to the application client. More preferably, if the local environment is selected in the parameter switch of the local-grid facade, the one or more tasks are scheduled to be executed on a local node of the local infrastructure, and preferably if the grid environment is selected in the parameter switch of the local-grid facade, the one or more tasks are scheduled to be executed on one or more of a plurality of grid nodes of the grid infrastructure. Preferably, the local-grid facade is implemented within the local infrastructure and within the grid infrastructure, such that the application can be executed either in the local environment or the grid environment selected for executing the application. Preferably, the local infrastructure includes the local node that is configured to execute the one or more tasks pertaining to the application and preferably, the grid infrastructure includes the plurality of grid nodes that are connected via a network communications channel, with each of the plurality of grid nodes being configured to execute one or more tasks pertaining to the application.

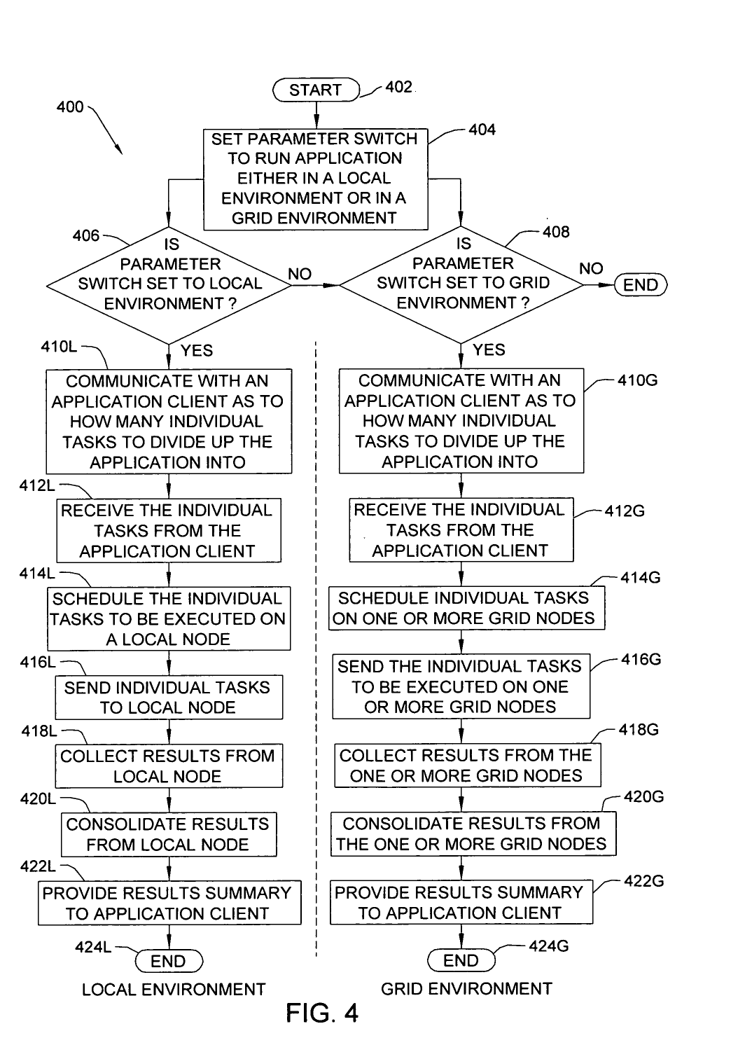

Reference is made to reference number 400 in FIG. 4, which illustrates a method of executing an application using the local-grid facade. When starting at step 402, the first step 404 is to set the parameter switch in the local-grid controller module of the local-grid facade, such that the local-grid controller module knows whether one or more tasks are to be executed in either a local environment or a grid environment. Preferably, the parameter switch is an XML parameter switch, which is set by an administrator before an application client sends any tasks pertaining to the application to be executed. If the parameter switch is set to a local environment in step 404, the application and any tasks or jobs or threads associated with the application will be executed in a local environment, as shown by the steps ending with an “L” on the left hand side of FIG. 4. However, if the parameter switch is set to a grid environment in step 406, the application and any tasks or jobs or threads associated with the application will be executed in a grid environment, as shown by the steps ending with a “G” on the right hand side of FIG. 4. If a local environment is selected in step 406, then the next step 410L involves communicating with an application client as to how many individual tasks or units of work to divide up the application into. The application client sends the individual tasks or jobs to the local-grid controller module in the local environment, which individual tasks are received from the application client by the local-grid controller module in step 412L. The local-grid controller module schedules the individual tasks to be executed on a local node in the local environment in step 414L. The local-grid controller module sends the individual tasks or jobs to the local node for execution in step 416L. After the individual tasks have been executed by the local node, the results collector module collects the results from the local node in step 418L and sends the results to the local-grid controller module. The local-grid controller module sends the collected results to the results summary module, which consolidates the results in step 420L and sends the consolidated results back to the local-grid controller module. Alternatively, the local-grid controller module receives the results and sends the results to the results collector module in step 418L. The results collector module collects the results and once all the results have been collected, the results collector module sends the results to the local-grid controller module in step 418L. The local-grid controller module sends the collected results to the results summary module, which consolidates the results in step 420L and sends the consolidated results back to the local-grid controller module. The local-grid controller module provides a summary of the results (also referred to as results summary) to the application client in step 422L, which ends the process at step 424L.

On the other hand, if a grid environment is selected in step 408, then the next step 410G involves communicating with an application client as to how many individual tasks or units of work to divide up the application into. In particular, the local-grid controller module determines the number of grid nodes that are available to execute tasks and informs the application client how many individual tasks to divide up the application into. The application client sends the appropriate number of individual tasks or jobs to the local-grid controller module in the grid environment, which individual tasks are received from the application client by the local-grid controller module in step 412G. The local-grid controller module schedules the individual tasks to be executed on one or more grid nodes in the grid environment in step 414G. The local-grid controller module sends the individual tasks or jobs to the one or more grid nodes for execution in step 416G. After the individual tasks have been executed by the one or more grid nodes, the results collector module collects the results from the individual grid nodes in step 418G and sends the results to the local-grid controller module. The local-grid controller module sends the results collected to the results summary module, which consolidates the results in step 420G and sends the consolidated results back to the local-grid controller module. Alternatively, the local-grid controller module receives the results and sends the results to the results collector module in step 418G. The results collector module collects the results and once all the results have been collected, the results collector module sends the results to the local-grid controller module in step 418G. The local-grid controller module sends the collected results to the results summary module, which consolidates the results in step 420G and sends the consolidated results back to the local-grid controller module. The local-grid controller module provides a summary of the results (also referred to as results summary) to the application client in step 422G, which ends the process at step 424G.

In yet another embodiment of the invention, there is provided a computer program product for executing an application. The computer program product includes a computer readable medium. Further, the computer program product includes first program instructions to execute an application in a local environment, second program instructions to execute the application in a grid environment and third program instructions to provide a parameter switch for selecting either the local environment or the grid environment for executing the application. Preferably, the computer program product further includes fourth program instructions to collect results corresponding to the execution of the application either in the local environment or the grid environment. In a preferred embodiment, the first, second, third and fourth program instructions are stored on the medium. If the parameter switch is selected or set for executing the application in the local environment, the third program instructions further includes instructions to schedule one or more tasks pertaining to the application in a local infrastructure, and if the parameter switch is selected for executing the application in the grid environment, the third program instructions further includes instructions to schedule one or more tasks pertaining to the application in a grid infrastructure. Preferably, the local infrastructure includes a local node configured to execute the one or more tasks pertaining to the application, and preferably the grid infrastructure includes a plurality of grid nodes connected via a network communications channel, each of the plurality of grid nodes being configured to execute the one or more tasks pertaining to the application. Preferably the local infrastructure is configured to receive an input pertaining to the application from an application client, and preferably the grid infrastructure is configured to receive an input pertaining to the application from the application client. In addition, the fourth program instructions preferably further includes instructions to consolidate results from either the local node or one or more of the plurality of grid nodes pertaining to the execution of the application.

Preferably, the computer program product is in a form accessible from the computer-usable or computer-readable medium, which provides program codes or instructions for use by or in connection with a computer or any instruction execution system. For the purposes of this description, a computer-usable or computer readable medium can be any apparatus that can contain, store, communicate, propagate, or transport the codes or instructions for use by or in connection with the instruction execution system, apparatus, or device. Preferably, the medium can comprise an electronic, magnetic, optical, electromagnetic, infrared, or semiconductor system (or apparatus or device) or a propagation medium. More preferably, the computer-readable medium can comprise a semiconductor or solid state memory, magnetic tape, a removable computer diskette, a random access memory (RAM), a read-only memory (ROM), a rigid magnetic disk and an optical disk. Further, examples of optical disks include compact disc—read only memory (CD-ROM), compact disc—read/write (CD-R/W) and digital versatile/video disc (DVD). The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

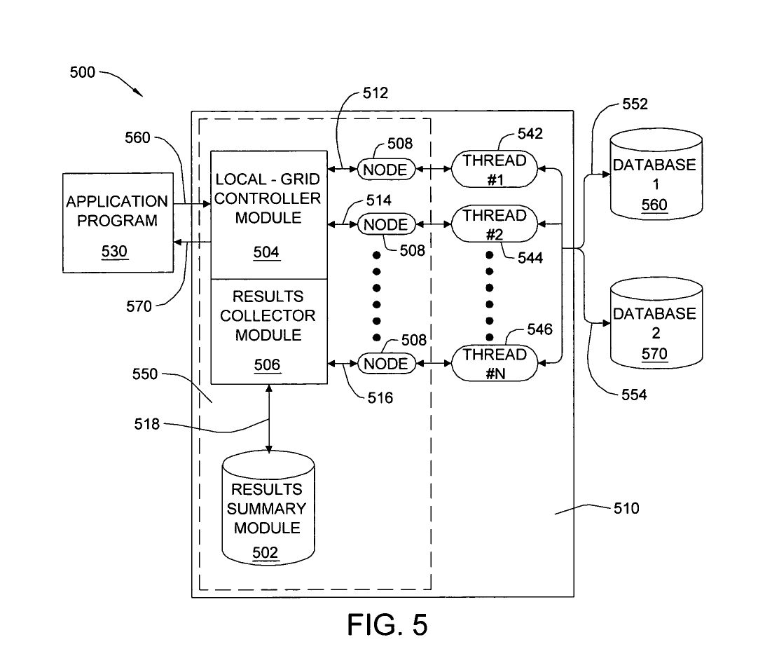

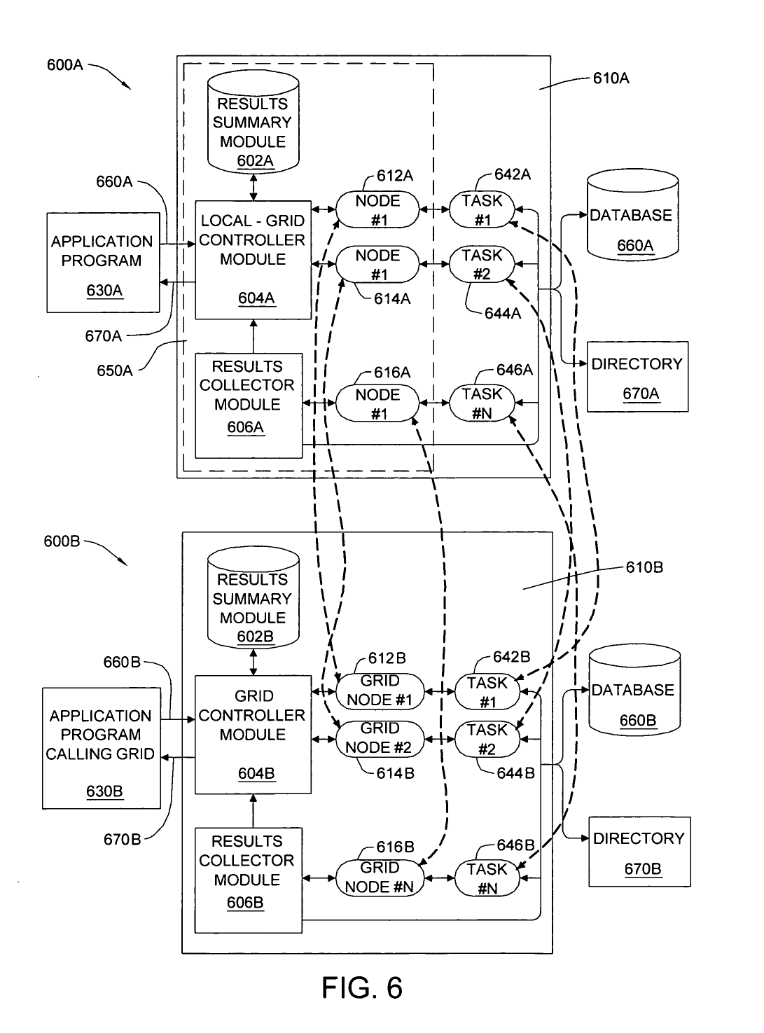

Reference is now made to FIGS. 5 and 6, which show examples of executing an application either in a local environment or a grid environment. Turning to FIG. 5, reference number 500 illustrates an example of an application being executed in a local environment 510 using the local-grid facade 550. In the example shown in FIG. 5, the parameter switch (not shown in FIG. 5) in the local-grid controller module 504 is set to execute the application in a local environment 510. For instance, the application client 530 needs to execute an application that makes a comparison of the data contained in database 1 (reference number 560) with the data contained in the database 2 (reference number 570). Accordingly, the application client 530 calls or communicates with the local-grid controller module 504 to find out how many tasks or jobs or threads to split up or divide the application into. The local-grid controller module 504 tracks or manages the resources available on the local node 508 and, as such, has the information pertaining to the local node, such as, processing capability, etc. and is able to communicate back to the application client 530 as to how many separate tasks/jobs/threads it can schedule for execution on the local node 508. As a result, the application client 530 divides the application for comparing the two databases 560 and 570 to be executed on the local node 508 into the appropriate number of tasks/jobs/threads corresponding to the task/job information communicated by the local-grid controller module 504. As shown in FIG. 5, the application program 530 sends (shown by the arrow 570) to the local-grid controller module 504 an appropriate number of tasks or jobs or threads (designated as thread #1, reference numbers 542, thread #2, reference number 544 and thread #N, reference number 546) pertaining to the application to be executed. The different thread #1 through thread #N refer to the fact that the local environment can execute anywhere from 1 to N number of threads depending on the local infrastructure. Preferably, the operating system of the local node 508 has implemented thereon multi-threading capabilities, so that multiple threads 542, 544 and 546 can be executed locally on the local node. Accordingly, the local-grid controller module 504 schedules the respective threads (shown by the solid double-sided arrows 512, 514 and 516) on the local node 508. As such, the several threads or jobs of the application comparing the two databases 560 and 570 may be executed concurrently, serially, or co-dependently on the local node 508. Each of the threads 542, 544 and 546 can access the data (shown by the arrows 552 and 554) contained in the two databases 560 and 570, respectively, such that the application that is executed as multiple threads on the local node can compare the two databases 560 and 570 and provide results in much less time than if the application was executed in its entirety on a local node. The results of the threads 542, 544 and 546 executed on the local node 508 are returned (shown by the double-sided arrows 512, 514, and 516) either to the local-grid controller module 504 or to the results collector module 506. If the local-grid controller module 504 receives the results, it may send the results to the results collector module 506. Further, the results collector module 506 may send (shown by double-sided arrow 518) the results to the results summary module 502 in order to consolidate the results into a summary, which is then sent back to the results collector module 506 and which in turn sends the results to the local-grid controller module 504. The local-grid controller module 504 sends (shown by arrow 570) the results of the execution of the application to the application client 530.

Turning to FIG. 6, FIG. 6 shows a side-by-side comparison of an application being executed in a local environment (reference number 600A) versus the same application being deployed onto a grid computing system (reference number 600B). In particular, reference number 600A in FIG. 6 shows the execution of an application that compares the data contained in database 660A with the data contained in the database 670A in a local environment 610A with the deployment of the same application that compares the data contained in database 660B with the data contained in the database 670B in a grid computing system 610B. The local environment shown in 600A is similar to the local environment described in FIG. 5, except that the tasks are referred to as threads in the example shown in 600A. Thus, the description of the local environment shown in FIG. 5 is applicable to the local environment shown in 600A and will not be repeated with respect to 600A. As such, even if a developer has access to a grid computing system, such as 600B, the execution of an application using the local-grid facade 650A in a local environment such as 600A, facilitates the deployment of the application onto a grid computing system, given that the application client 630A already has a better understanding of how to divide up the application in order to deploy the application in a grid computing system 610B. For instance, the application client 630B is likely to call a grid controller module 604B that is part of the grid computing system. The grid controller module 604B manages the one or more grid nodes 612B, 614B and 616B in the system and schedules the one or more tasks on one or more grid nodes. As such, when deploying the application in a grid computing system, task #1 (642A), task #2 (644A) through task #N (646A) that are executed on the local node #1 (designated as 612A, 614A and 616A) shown in 600A can be deployed as task #1 (642B), task #2 (644B) through task #N (646B) on the respective grid nodes shown in 600B, namely, grid node #1 (612B), grid node #2 (614B) and grid node #3 (616B). This is further shown by the dotted arrows from the respective nodes and tasks in 600A to the respective nodes and tasks in 600B and vice versa, where the respective local nodes, 612A, 614A and 616A correspond to the respective grid nodes 612B, 614B and 616B and the respective tasks, 642A, 644A and 646A executed in the local environment 600A correspond to the respective tasks, 642B, 644B and 646B deployed in the grid computing system 600B. Also, as shown in 600B, the local-grid controller module 604A in 600A translates into similar functions being carried out by a grid controller module 604B in a grid computing system 600B. The grid computing system 600B may also have a results collector module 606B and a results summary module 602B that correspond to the results collector module 606A and the results summary module 602A that carry out the respective functions described herein above with respect to FIG. 5. However, in an alternative embodiment of the grid computing system (not shown in 600B), the grid controller module may carry out the functions of the results collector module and the results summary module. Thus, as illustrated in FIG. 6, the execution of an application first in a local environment using a local-grid facade can take some risk out of deploying an application directly in a grid computing system.

Accordingly, the local-grid facade provides a simpler version or simulation of a grid framework to increase resource utilization on a single workstation, local node or server and also allows developers to use this framework to build applications using a local development environment that is suitable for any grid framework or system. Further, an application developed using a local-grid facade provides an opportunity to increase the resource utilization on the local node or server, resulting in much better throughput. Also, the greater the number of local nodes there are, the better the throughput will be. Further, the local-grid facade simplifies the problem of dealing with complicated system architecture of a grid framework when building or developing applications for a grid system given that application developers can use or implement the local-grid facade to build applications by dividing the task into multiple, parallel tasks/jobs/threads or units of work and test the implementation locally. Thus, the local-grid facade provides application developers a simulation of a grid framework in the local development environment without any need for an actual grid framework, since the local-grid facade already has divided the job into sub-jobs/tasks/threads it is easy for an application deployer to understand the deployment structure easily and to be able to deploy the application in a grid system.

The foregoing descriptions of specific embodiments of the present invention have been presented for the purpose of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A system for executing an application, said system comprising:
a local infrastructure configured to execute an application in a local environment;
a grid infrastructure configured to execute said application in a grid environment; and
a local-grid facade having a parameter switch for selecting either said local environment or said grid environment and for executing said application in the selected environment.

2. The system according to claim 1, wherein said local-grid facade is implemented within each of said local infrastructure and said grid infrastructure.

3. The system according to claim 2, wherein said local infrastructure comprises a local node configured to execute one or more tasks pertaining to said application.

4. The system according to claim 2, wherein said grid infrastructure comprises:
a plurality of grid nodes connected via a network communications channel, wherein each of said plurality of grid nodes is configured to execute one or more tasks pertaining to said application.

5. The system according to claim 3, wherein said local-grid facade implemented within said local infrastructure further comprises:
a local-grid controller module configured to schedule said one or more tasks to be executed on said local node, wherein said local-grid controller module includes said parameter switch; and
a results collector module configured to collect results pertaining to said one or more tasks executed on said local node.

6. The system according to claim 4, wherein said local-grid facade implemented within said grid infrastructure further comprises:
a local-grid controller module configured to schedule said one or more tasks on one or more of said plurality of grid nodes; and
a results collector module configured to collect results pertaining to said one or more tasks from said local node.

7. The system according to claim 6, wherein said local environment comprises said local infrastructure having said local-grid facade implemented thereon, such that said local environment is configured to test and deploy said application in said local environment; and wherein said grid environment comprises said grid infrastructure having said local-grid facade implemented thereon, such that said grid environment is configured to deploy said application in said grid environment.

8. The system according to claim 6, wherein said local infrastructure is configured to receive an input pertaining to said execution of said application from an application client; and wherein said grid infrastructure is configured to receive an input pertaining to said execution of said application from said application client.

9. The system according to claim 8, wherein said local environment includes a results summary module configured to consolidate results pertaining to said one or more tasks received from said local node; and wherein said grid environment includes a results summary module configured to consolidate results pertaining to said one or more tasks received from said one or more of said plurality of grid nodes.

10. A method for executing an application, said method comprising the steps of:
providing a local-grid facade having a parameter switch for selecting either a local environment or a grid environment for executing an application;
selecting either said local environment or said grid environment for executing said application;
receiving one or more tasks pertaining to said application to be executed; and
executing said one or more tasks in either said local environment or said grid environment selected.

11. A method according to claim 10, further comprising the step of:
forwarding to an application client results corresponding to said one or more tasks executed in either said local environment or said grid environment selected.

12. A method according to claim 11, wherein said receiving step further comprises the step of:
communicating with said application client as to how many tasks to divide said application into for execution in either said local environment or said grid environment selected; and
scheduling said one or more tasks received from said application client for execution in either said local environment or said grid environment selected.

13. A method according to claim 11, wherein said forwarding step further comprises the steps of:
collecting said results corresponding to said one or more tasks executed either in said local environment or said grid environment selected; and
providing a summary of said results collected to said application client.

14. A method according to claim 12, wherein if said local environment is selected in said parameter switch, said one or more tasks are scheduled to be executed on a local node of said local infrastructure; and wherein if said grid environment is selected in said parameter switch, said one or more tasks are scheduled to be executed on one or more of a plurality of grid nodes of said grid infrastructure.

15. A computer program product for executing an application, said program product comprising:
a computer readable medium;
first program instructions to execute an application in a local environment;
second program instructions to execute said application in a grid environment;
third program instructions to provide a parameter switch for selecting either said local environment or said grid environment for executing said application; and wherein said first, second and third program instructions are stored on said medium.

16. A computer program product according to claim 15, further comprising:
fourth program instructions to collect results corresponding to the execution of said application either in said local environment or said grid environment, wherein said fourth program instructions are stored on said medium.

17. A computer program product according to claim 15, wherein if said parameter switch is selected for executing said application in said local environment, said third program instructions further includes instructions to schedule one or more tasks pertaining to said application in a local infrastructure; and wherein if said parameter switch is selected for executing said application in said grid environment, said third program instructions further includes instructions to schedule one or more tasks pertaining to said application in a grid infrastructure.

18. A computer program product according to claim 17, wherein said local infrastructure comprises a local node configured to execute said one or more tasks pertaining to said application; and wherein said grid infrastructure comprises a plurality of grid nodes connected via a network communications channel, each of said plurality of grid nodes being configured to execute said one or more tasks pertaining to said application.

19. A computer program product according to claim 18, wherein said local infrastructure is configured to receive an input pertaining to said application from an application client; and wherein said grid infrastructure is configured to receive an input pertaining to said application from said application client.

20. A computer program product according to claim 19, wherein said fourth program instructions includes instructions to consolidate results from either said local node or one or more of said plurality of grid nodes pertaining to the execution of said application.
